(19) United States
(12) Patent Application Publication
(10) Pub. No.: US 2002/0093455 A1
(43) Pub. Date: Jul. 18, 2002

(54) Hand-held radio-frequency transceiver particularly useful as a cellular telephone handset

(75) Inventor: Moshe Einat, Ramat Gan (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: E-MOBILE ISRAEL LTD.

(21) Appl. No.: 09/759,199

(22) Filed: Jan. 16, 2001

(51) Int. Cl. H01Q 1/24

(52) U.S. Cl. 343/702; 343/700 MS

(57) ABSTRACT

A hand-held radio-frequency transceiver particularly useful as a cellular telephone handset includes an internal antenna applied as printed circuitry on the inner face of the removable back cover of the hand set housing.

### FIELD AND BACKGROUND OF THE INVENTION

The present invention relates to hand-held radio frequency transceivers. The invention is particularly useful in cellular telephone handsets, and is therefore described below with respect to this application.

Hand-held radio-frequency transceivers in general, and particularly cellular telephone handsets (which term is intended to include PDAs, personal digital assistants, performing cellular telephone functions), are continuously being miniaturized in order to make them more convenient to carry and to use. However, using small antennas reduces their efficiency, and therefore requires more power to be supplied to operate the device. Since such devices include their own battery supply, the level of power required to operate the device bears a direct relation on the frequency for recharging the battery or for replacing it. In addition, since such devices are operated close to the human head, there is serious concern that the power level may have a detrimental effect on the health of the user.

The current cellular telephone handsets generally include an external retractable antenna. However, external antennas detract from the external appearance of the handset, as well as increase their overall size thus making them less convenient to carry.

A number of cellular telephone handsets including internal antennas have been developed and are described in the patent literature, for example in WO 99/13528 published Mar. 18, 1999, U.S. Pat. No. 5,945,954 issued Aug. 31, 1999, and U.S. Pat. No. 6,025,802 issued Feb. 15, 2000. The telephone handset described in WO 99/13528 includes a loop directive antenna; whereas the handsets described in the above two U.S. Patents include slot-type antennas. In all these cases, the antenna is applied, as by printed circuitry, to a face of a dielectric member included within the housing at a predetermined distance from the ground plane within the housing of the device.

### OBJECT AND BRIEF SUMMARY OF THE PRESENT INVENTION

An object of the present invention is to provide a hand-held radio-frequency transceiver in general, or a cellular telephone handset in particular, with a built-in antenna such as to minimize the size, volume and weight of the device.

According to one aspect of the present invention, there is provided a hand-held radio-frequency transceiver, comprising: a housing having a front side including a speaker and a microphone; a rear side; radio-frequency transceiver circuitry within the housing; a conductive ground plane within the housing; and an antenna for transmitting and receiving radio-frequency signals; characterized in that the housing includes an insulating panel which constitutes an outer wall of the housing, and which carries the antenna thereon spaced from the conductive ground plane and electrically connected to the radio-frequency transceiver circuitry.

According to another aspect of the present invention, there is provided a cellular telephone handset, comprising: a housing having a front side including a speaker and a microphone; a rear side; cellular telephone circuitry within the housing; a conductive ground plane within the housing; and an antenna for transmitting and receiving radio-frequency signals; characterized in that the housing includes an insulating panel which constitutes an outer wall of the housing, and which carries the antenna thereon spaced from the conductive ground plane and electrically connected to the cellular telephone circuitry.

According to further features in the preferred embodiments of the invention described below, the antenna is carried on the inner face of the insulating panel constituting the rear cover of the housing, and is in the form of a printed circuit. The rear cover is removably attachable to the housing, and the antenna is electrically connected to the cellular telephone circuitry by contact pins carried by the housing engageable with conductive pads carried by the insulating panel when the insulating panel is attached to the housing.

As will be described more particularly below hand-held radio-frequency transceivers, particularly cellular telephone handsets constructed in accordance with the foregoing features provide a number of important advantages: Since the antenna is printed on the inner face of the insulating panel constituting the rear side of the housing, the antenna adds negligible volume and weight to the housing. In addition, since the antenna is disposed outwardly of the conductive ground plane, the ground plane provides a measure of shielding of the user's head against the radiation produced by the antenna, thereby not only improving directivity of the antenna, but also reducing the SAR (specific absorption rate). Since the back insulating panel or cover of the housing can be completely used for the antenna, the antenna can be of optimum size for optimum efficiency. In addition, since the antenna is applied by printed circuit techniques, it can be produced in volume and at low cost.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a side elevational view diagrammatically illustrating a cellular telephone handset constructed in accordance with the present invention;

FIG. 2 illustrates the front side of the handset of FIG. 1;

FIG. 3 illustrates one example of an antenna which can be applied to the inner face of the back cover of the housing in the device of FIG. 1; and

FIGS. 4 and 5 illustrate two further types of antennas which can be applied to the inner face of the back cover in the device of FIG. 1.

### DESCRIPTION OF PREFERRED EMBODIMENTS

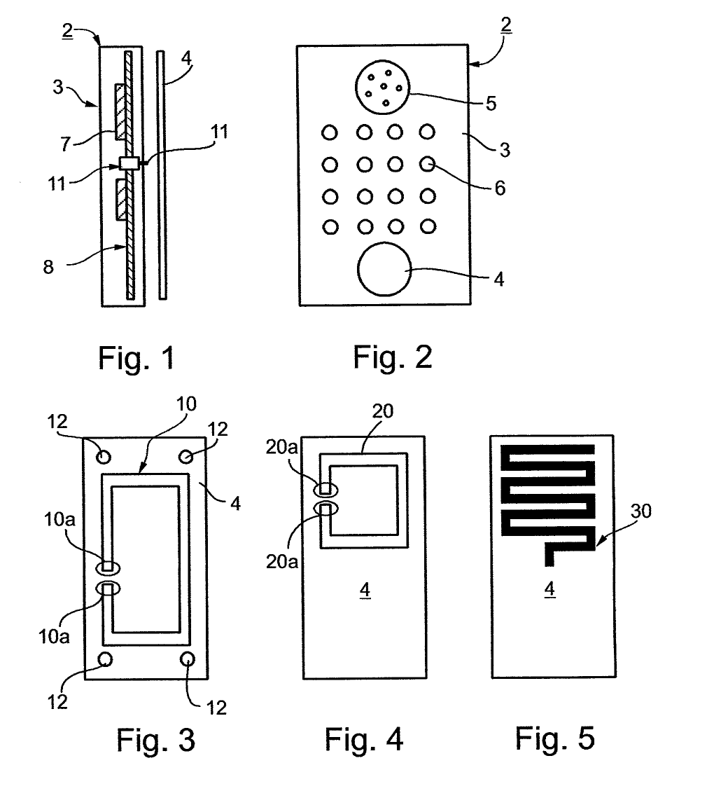

The device illustrated in FIGS. 1-3 is a cellular telephone handset which includes a housing, generally designated 2, having a front side 3 and a rear side in the form of a cover 4 removably attachable to the housing 2. As shown in FIG. 2, the front side 3 of the housing includes a microphone 4 for picking-up the sounds to be transmitted, a speaker 5 for reproducing the sounds received by the handset, and operational buttons 6 for dialing purposes or for performing the other operational functions of a cellular telephone handset of this type.

The cellular telephone circuitry within housing 2 is schematically shown at 7 in FIG. 1. Also schematically shown in FIG. 1 is the electrically-conductive ground plane 8 commonly included in cellular telephone handsets of this type.

Since the above-described components of cellular telephone handsets are well known and do not constitute a part of the present invention, further details of their construction and operation are not set forth herein.

According to the present invention, the antenna is carried by the back cover 4 such that it is spaced from the conductive ground plane 8 as required, and is also electrically connected to the cellular telephone circuitry 7.

FIG. 3 illustrates one example of the antenna configuration. In this example, the conductive pattern constituting the antenna 10 is in the form of a rectangular loop and is applied by printed circuitry techniques to the inner face of the rear cover 4. The antenna pattern 10 is further provided with pads 10a, 10b contactable by contact pins 11 connected to the circuitry 7 within the housing 2 so as to connect the antenna to that circuitry when the rear cover 4 is applied to close the rear end of the housing.

FIG. 3 also illustrates the rear cover 4 as being formed with openings 12 for receiving fasteners when applying the rear cover to the housing.

In the example illustrated in FIG. 3, the antenna conductive pattern 10 occupies substantially the complete inner surface of the rear cover 4.

FIG. 4 illustrate a variation wherein the antenna conductive pattern, therein designated 20, occupies only about one-half of the back cover 4 so as not to extend into the area of the back cover grasped by the user. The antenna 20 illustrated in FIG. 4, is otherwise of the same loop type as illustrated in FIG. 3, and includes the conductive pads 20a, 20b for making the electrical connections to the telephone circuitry 7 via the contact pins 11.

FIG. 5 illustrates another type of conductive pattern which may be used for the antenna 30, also printed on the inner face of the rear cover 4.

In all the described embodiments, the conductive pattern defining the antenna (10, 20, 30) may be left bare, or may be covered by an insulating layer, such as a insulation coating.

It will be appreciated that other antenna patterns can be used, and that many other variations, modifications and applications of the invention may be made.

What is claimed is:

1. A hand-held radio-frequency transceiver, comprising:
a housing having a front side including a speaker and a microphone; a rear side; radio-frequency transceiver circuitry within the housing; a conductive ground plane within the housing; and an antenna for transmitting and receiving radio-frequency signals;
characterized in that said housing includes an insulating panel which constitutes an outer wall of the housing, and which carries said antenna thereon spaced from said conductive ground plane and electrically connected to said radio-frequency transceiver circuitry.

2. The transceiver according to claim 1, wherein said antenna is carried on the inner face of said insulating panel and said insulating panel constitutes the rear cover of the housing.

3. The transceiver according to claim 2, wherein said inner face of the insulating panel constituting the rear cover of the housing includes a layer of insulating material overlying said antenna.

4. The transceiver according to claim 1, wherein said antenna is in the form of a printed circuit carried on said insulating panel.

5. The transceiver according to claim 1, wherein said insulating panel is removably attachable to said housing to constitute a removable rear cover of the housing, and said antenna is electrically connected to said radio-frequency transceiver circuitry by contact pins carried by said housing engageable with conductive pads carried by said rear cover when said rear cover is attached to said housing.

6. The transceiver according to claim 1, wherein said antenna is in the form of a loop.

7. The transceiver according to claim 1, wherein said antenna occupies only the upper portion of said insulating panel.

8. The transceiver according to claim 1, wherein said antenna occupies a major portion of the surface area of said insulating panel.

9. A cellular telephone handset, comprising:
a housing having a front side including a speaker and a microphone; a rear side; cellular telephone circuitry within the housing; a conductive ground plane within the housing; and an antenna for transmitting and receiving radio-frequency signals;
characterized in that said housing includes an insulating panel which constitutes an outer wall of the housing, and which carries said antenna thereon spaced from said conductive ground plane and electrically connected to said cellular telephone circuitry.

10. The cellular telephone handset according to claim 9, wherein said antenna is carried on the inner face of said insulating panel and said insulating panel constitutes the rear cover of the housing.

11. The cellular telephone handset according to claim 10, wherein said inner face of the insulating panel constituting the rear cover of the housing includes a layer of insulating material overlying said antenna.

12. The cellular telephone handset according to claim 9, wherein said antenna is in the form of a printed circuit carried on said insulating panel.

13. The cellular telephone handset according to claim 9, wherein said insulating panel is removably attachable to said housing to constitute a removable rear cover of the housing, and said antenna is electrically connected to said cellular telephone circuitry by contact pins carried by said housing engageable with conductive pads carried by said insulating panel when said insulating panel is attached to said housing.

14. The cellular telephone handset according to claim 9, wherein said antenna is in the form of a loop.

15. The cellular telephone handset according to claim 9, wherein said antenna occupies only the upper portion of said insulating panel.

16. The cellular telephone handset according to claim 9, wherein said antenna occupies a major portion of the surface area of said insulating panel.

17. A cellular telephone handset, comprising:
a housing having a front side including a speaker and a microphone; a rear side; cellular telephone circuitry within the housing; a conductive ground plane within the housing; and an antenna for transmitting and receiving radio-frequency signals;
said rear side of the housing being closed by a removable back cover of insulating material removably attachable to said housing;
said antenna being in the form of printed circuitry carried on the inner face of said removable back cover, spaced from said conductive ground plane, and electrically connected to said cellular telephone circuitry.

18. The cellular telephone handset according to claim 17, wherein said antenna is electrically connected to said cellular telephone circuitry by contact pins carried by said housing engageable with conductive pads carried by said removable back cover when attached to said housing.

19. The cellular telephone handset according to claim 17, wherein said antenna is in the form of a loop.

20. The cellular telephone handset according to claim 17, wherein said antenna occupies only the upper portion of said removable back cover.
